(19) United States
(12) Patent Application Publication
(10) Pub. No.: US 2018/0372589 A1
(43) Pub. Date: Dec. 27, 2018

(54) DEVICE FOR MEASURING A FIELD OF PRESSURES EXERTED BY A PNEUMATIC TIRE

(71) Applicant: MICHELIN RECHERCHE ET TECHNIQUE S.A., Granges-Paccot (CH)

(72) Inventors: THIBAUT ANSOUD, Clermont-Ferrand (FR); FLORIAN BREMOND, Clermont-Ferrand (FR); JOSÉ APARICIO, Clermont-Ferrand (FR); RÉMI REYNAL DE ST-MICHEL, Clermont-Ferrand (FR)

(73) Assignee: MICHELIN RECHERCHE ET TECHNIQUE S.A., Suisse (FR)

(21) Appl. No.: 16/065,388

(22) PCT Filed: Dec. 20, 2016
(86) PCT No.: PCT/FR2016/053567

§ 371 Date: Jun. 22, 2018

(30) Foreign Application Priority Data
Dec. 22, 2015 (FR) 1563130

(51) Int. Cl. G01M 17/02; G01L 5/16

(52) U.S. Cl. CPC G01M 17/021; G01L 5/165; G01L 5/162

(57) ABSTRACT

A device for measuring a field of pressures exerted by a tire in the area of the measurement surface with which it is in contact, the device including a flat support and a sensor for measuring the field of pressures, which sensor is arranged on the support. The device includes at least one sheet (“protective sheet”) of a thickness less than 1 mm, and made from a material able to withstand forces generated in its plane, greater than or equal to 1000 N and less than or equal to 10 000 N, the sheet being arranged over the measurement sensor so as to be in contact therewith and to be immobilized with respect thereto, the sheet being prestressed so as to be stretched over the sensor.

### GENERAL TECHNICAL FIELD

The invention lies in the field of measuring the field pressures exerted on the ground by a tyre.

These pressure measurements are a key parameter in understanding tyre performances, whether these tyres be intended for passenger vehicles, heavy duty vehicles, construction plant vehicles or two-wheeled vehicles, particularly in terms of tyre wear, grip or rolling resistance for example.

The present invention relates more specifically to a device for measuring a field of pressures exerted by a tyre in the area of the measurement surface with which it is in contact.

### PRIOR ART

Measurement devices known from the prior art comprise a flat support on which there is placed a sensor, likewise flat, for measuring the field of pressures, and preferably of the piezo-resistive or piezo-capacitive type. The tyre that is to be tested is then mounted on a test bed and pressed against this measurement sensor with a certain force which simulates the force that this tyre exerts on the road surface or the ground during its use.

This force is exerted along an axis perpendicular to the contact patch (contact surface) in which the tyre is in contact with the ground.

These measurement devices are suitable when the tyre is tested while stationary or when running in a straight line.

However, when there is a desire to test the tyre under braking conditions, cornering slip conditions (namely a situation in which the vehicle is taking a bend), or conditions of camber angle (namely taking account of the fact that the rolling plane of the wheel is at an angle to the vertical), it is found that the forces generated in the plane of contact (plane of friction) of the tyre with the sensor are very high.

These forces are chiefly traction and/or shear forces. They may exceed 1000 N. The applicant company has been able to observe that the aforementioned forces irreversibly damage the sensor.

A device for analysing the contact pressure of a tyre on the ground is already known from U.S. Pat. No. 5,641,900. This device comprises a flat support, on which a plurality of sensing cells are disposed. These cells are covered with a protective sheet

According to a first embodiment, this protective sheet is simply fixed by two of its sides. As a result, the protective sheet is not immobilized with respect to the sensing cells and may be damaged and creased when the tyre applied thereon is subjected to traction and/or shear forces. This results in a poor transmission, to the sensing cells of the measured pressure fields.

According to a second embodiment, the protective sheet is glued directly to the sensing cells. In this case, it is impossible to test the tyre under braking, cornering slip (drift) or camber conditions, since this would result in the destruction of the sensor cells secured to the protective sheet and thus subjected to the same traction and/or shear forces.

### SUMMARY OF THE INVENTION

Therefore, the object of the invention is to overcome the aforementioned disadvantages of the prior art.

The invention relates to a device for measuring a field of pressures exerted by a tyre in the area of the measurement surface with which it is in contact, this device comprising a flat support and a sensor for measuring this field of pressures, which sensor is arranged on said support.

It is an objective of the invention to offer a measurement device like the aforementioned one, which is more robust than the known device of the prior art, which prevents its measurement sensor from being destroyed and which does not significantly alter the resolution of the sensor.

According to the invention, this device comprises at least one sheet, referred to as “protective sheet”, arranged over said measurement sensor and against the upper face of which the tyre that is to be tested is intended to be pressed, this protective sheet has a thickness less than 1 mm, preferably less than 0.2 mm, and is made from a material able to withstand forces, notably shear forces and traction forces, generated in its plane, greater than or equal to 1000 N and less than or equal to 10 000 N, this protective sheet is arranged over said measurement sensor in such a way as to be in contact therewith and to be immobilized with respect thereto, and this protective sheet is prestressed so as to be stretched over said measurement sensor.

To the surprise of the man skilled in the art, it was found that this protective sheet enabled the measurement sensor to be protected from the forces generated in the plane of friction, without significantly impairing the resolution and the results of the measurements obtained by the sensor. The invention therefore goes against the prejudice that interposing a protective sheet between a sensor and a tyre prevents the sensor from operating or greatly disturbs the results obtained.

According to other advantageous and nonlimiting features of the invention, considered alone or in combination:
said protective sheet is not secured to said measurement sensor;
said protective sheet is made from a metallic material, preferably stainless steel, or from a carbon fibre-based or aromatic polyamide fibre-based composite material;
if the protective sheet and the upper face of the measurement sensor are electrically conductive, said protective sheet is covered with an electrically insulating film placed between the sensor and said protective sheet and the sum of the thicknesses of the protective sheet and of the electrically insulating film is less than 1 mm,
the thickness of said protective sheet or the sum of the thicknesses of the protective sheet and of the electrically insulating film is less than 0.2 mm;
said protective film is prestressed to values greater than 0 N and less than or equal to 500 N;
said protective film is prestressed by being wound at both ends around a roller, at least one of these two rollers being a tensioning roller;
the measurement sensor is a piezo-resistive or piezo-capacitive sensor;
said measurement sensor has a resolution less than or equal to 5 mm², preferably less than 2.5 mm², more preferably less than or equal to 1 mm²;
the device comprises a central processing unit of a computer and the measurement sensor comprises a connectivity member allowing the connection of an electric power supply lead and of a lead for connecting to said central processing unit.

### DESCRIPTION OF THE FIGURES

Further features and advantages of the invention will become apparent from the description which will now be given thereof, with reference to the attached drawings which, by way of non-limiting example, depict one possible embodiment thereof.

In these drawings:

FIG. 1 is a schematic perspective view of the measurement device according to the invention and of a tyre in the process of being measured using this device, and

FIG. 2 is a schematic view in vertical cross section of the measurement device according to the invention.

### DETAILED DESCRIPTION

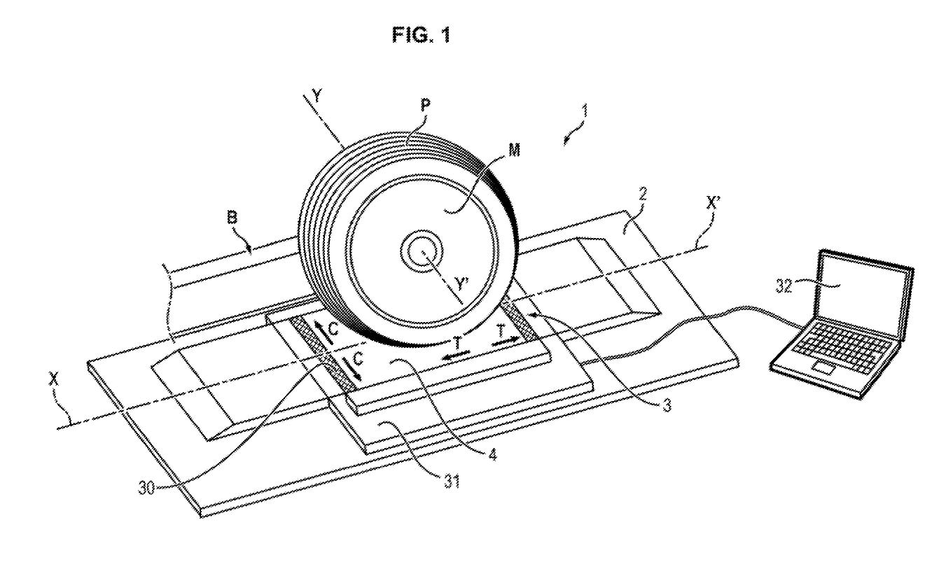

The overall structure of the device for measuring a field of pressures exerted by a tyre in its contact patch in which it is in contact with the ground will now be described with reference to FIG. 1.

This measurement device 1 comprises a flat support 2 and a measurement sensor 3, arranged on this support 2.

The support 2 is generally a measurement bench but could equally be the ground.

The sensor 3 is preferably a piezo-resistive or piezo-capacitive sensor.

More specifically, the sensor 3 has a measurement tile (plate) 30, a connectivity member 31, that allows the electric power supply lead and lead connecting the measurement tile and a central processing unit 32 of a computer to be connected to it.

To give an idea of scale, the measurement tile 30 preferably exhibits a measurement area of 5 cm by 5 cm or more.

The tyre P to be tested is mounted on a hub M of a test bed B. More specifically, this hub M is mounted with the ability to rotate about an axis of rotation Y-Y′ with respect to the test bed B, and the tyre is mounted on the hub M in such a way that the central axis of this tyre coincides with the axis of rotation Y-Y′ of the hub. The measurement device 1 has a longitudinal axis X-X′ substantially perpendicular to the axis of rotation Y-Y′ of the hub and therefore of the tyre.

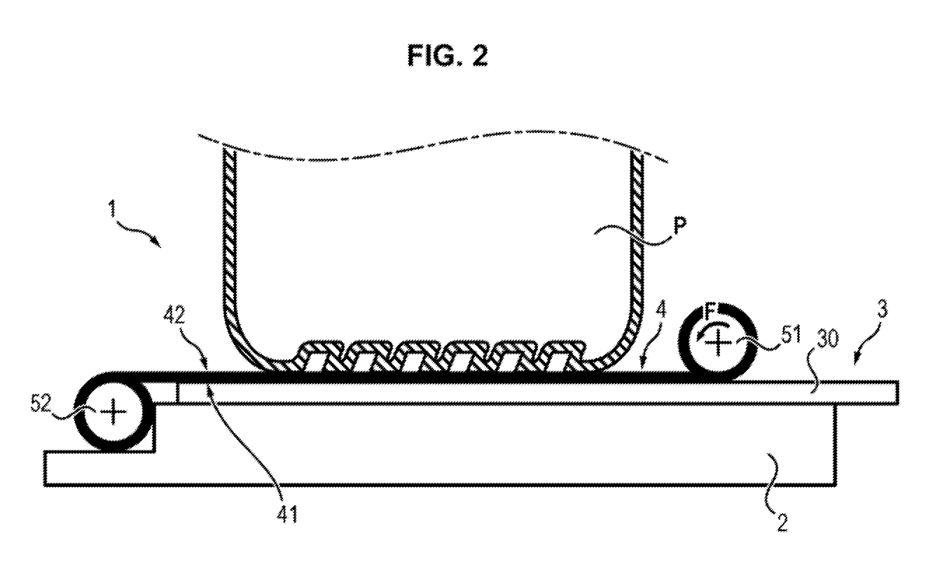

According to the invention, and as can also be seen in FIG. 2, the measurement tile 30 is covered with a protective sheet 4.

The measurement device 1 according to the invention makes it possible to measure a field of pressures exerted by a tyre P in its contact patch in which it is in contact with said protective sheet 4 covering the measurement sensor 3. The results of these measurements are considered to correspond to the pressures exerted by the tyre P when it is on the ground or the road surface.

The protective sheet 4 is chosen to have a resistance to forces (notably shear and traction forces) generated in its plane and greater than or equal to 1000 N and less than or equal to 10 000 N. The lower value makes it possible to ensure that the protective sheet 4 will not be damaged during the tests commonly conducted on tyres P. The higher value corresponds to the upper limit imposed by the measurement sensor 3 and beyond which this sensor would be destroyed.

As explained hereinabove, the forces are chiefly shear forces (arrows C), which are exerted in a direction parallel to the axis Y-Y′ to the left or to the right with respect to the tyre P, traction forces (arrows T), which are exerted in a direction perpendicular to the axis Y-Y′ forward or backward and/or forces which correspond to the resultant of the aforementioned shear and traction forces.

This protective sheet 4 is arranged over the measurement sensor 3 (and more specifically over the measurement tile 30) in such a way that its underside face 41 is in contact with this tile 30. Furthermore, the sheet 4 is immobilized with respect to this tile 30 in such a way that it cannot slip and separate therefrom.

The tyre P is intended to be pressed against the upper face 42 of the sheet 4.

Furthermore, preferably, this protective sheet 4 is prestressed, which means to say that it is stretched over said measurement sensor 3, so as not to exhibit any wrinkles. This pre-stressing, however, remains below the elastic limit of the protective sheet 4.

For preference, however, this protective sheet 4 is not secured to the measurement sensor 3. For example, it is not bonded thereto. Thus, when the tyre exerts aforementioned shear and/or traction forces, it is this protective sheet 4 which withstands said forces but does not pass them on to the measurement sensor 3.

Tests conducted by the applicant company have made it possible to determine the preferred parameters for the protective sheet 4.

For preference, this protective sheet 4 is made from a material selected from metals, preferably stainless steel, or from a carbon fibre-based or aromatic polyamide fibre-based composite material.

Depending on the type of sensor 3 used, and notably on whether the measurement tile 30 thereof is electrically conducting, it is then necessary for the protective sheet 4 to be made from an electrically insulating material. If it is not, this protective sheet 4 is then covered with an electrically insulating film interposed between the measurement tile 30 of the sensor and the protective sheet 4.

The measurement sensor 3 used preferably has a resolution of below 5 mm², more preferably below 2.5 mm² or even better of close to 1 mm².

The tests conducted by the applicant company have demonstrated that the protective sheet 4 preferably needs to have a thickness of less than 1 mm, more preferably of less than 0.2 mm, in order to maintain the resolution of the sensor 3.

The man skilled in the art is able to determine the minimum thickness of the protective sheet depending on the chosen material, so that it has a resistance to forces generated in its plane greater than or equal to 1000 N and less than or equal to 10000 N. Preferably, this thickness is greater than 0.01 mm.

By way of purely illustrative example, the protective sheet may be a metal strip of about 0.05 mm.

In order to ensure that the protective sheet 4 is correctly immobilized with respect to the sensor 3 and prestressed, it is possible, as depicted in one exemplary embodiment of FIG. 2, for the two ends of the protective sheet 4 to be wound around two rollers, referenced 51 and 52 respectively.

These rollers 51, 52 may be covered with a layer of elastomer thick enough to maximize the retention of the protective sheet 4 and remove the effect of any lack of flatness of the surfaces (for example machining tolerance, bowing of the rollers under load, etc.).

One of these rollers is, for example, fixed, while the other may be a tensioning roller. Thus, for example, the roller 52 may be fixed, the protective sheet 4 being trapped (pinched) between this roller and the support 2, whereas the roller 51 may be wound (rotated) on itself in such a way as to tension the protective sheet 4 (arrow F). The two rollers 51 and 52 may also be tensioning rollers able to be rotated on themselves.

The two opposing rollers 51, 52 may also be laterally mobile so that they can be parted in order to tension the protective sheet 4.

Tests have been conducted with the measurement device 1 equipped with the aforementioned protective sheet 4.

A tyre P was mounted on the test bed and pressed against the protective sheet 4 and subjected to conditions of braking, of cornering slip up to an angle of 15° and of camber. That generated forces in the plane of said protective sheet 4. As a reminder, it is recalled that the slip angle is an angle formed in the plane of the protective sheet 4 with respect to the longitudinal axis X-X′ of the measurement device 1 to the right or to the left thereof according to the pivoting of the hub M carrying the tyre P.

It was found that neither this protective sheet 4 nor the sensor 3 were damaged when subjected to forces generated in the plane of said protective sheet that were greater than or equal to 1000 N and ranging up to 10 000 N.

Furthermore, the results of the pressure field measurements obtained are repeatable, exploitable, and consistent with the resolution of the sensor 3, meaning that the sheet 4 does not significantly disturb the measurement results obtained using this sensor.

1. A device for measuring a field of pressures exerted by a tire in an area of the a measurement surface with which the tire is in contact, the device comprising:
a flat support;
a sensor for measuring the field of pressures, which sensor is arranged on the support; and
at least one protective sheet arranged over the sensor and against an upper face of which the tire that is to be tested is to be pressed,
wherein the protective sheet has a thickness less than 1 mm, and is made from a material able to withstand forces generated in its plane that are greater than or equal to 1000 N and less than or equal to 10000 N,
wherein the protective sheet is arranged over the sensor in such a way as to be in contact therewith and to be immobilized with respect thereto, and
wherein the protective sheet is prestressed so as to be stretched over the sensor.

2. A device according to claim 1, said wherein the protective sheet is not secured to the sensor.

3. A device according to claim 1, said wherein the protective sheet is made from a metallic material.

4. A device according to claim 1, wherein the protective sheet is made from a carbon fiber-based composite material or an aromatic polyamide fiber-based composite material.

5. A device according to claim 1, if wherein the protective sheet and an upper face of the sensor are electrically conductive,
wherein the protective sheet is covered with an electrically insulating film placed between the sensor and the protective sheet, and
wherein a sum of thicknesses of the protective sheet and of the electrically insulating film is less than 1 mm.

6. A device according to claim 5, wherein a thickness of the protective sheet or a sum of thicknesses of the protective sheet and of the electrically insulating film is less than 0.2 mm.

7. A device according to one of the preceding claim 1, wherein the protective sheet is prestressed to values greater than 0 N and less than or equal to 500 N.

8. A device according to claim 1, wherein the protective sheet is prestressed by being wound at both ends around respective rollers, at least one of the rollers being a tensioning roller.

9. A device according to claim 1, wherein the sensor is a piezo-resistive sensor or a piezo-capacitive sensor.

10. A device according to claim 1, wherein the sensor has a resolution less than or equal to 5 mm².

11. A device according to claim 1, wherein the sensor has a resolution less than 2.5 mm².

12. A device according to claim 1, further comprising a central processing unit of a computer,
wherein the sensor comprises a connectivity member allowing the connection of an electric power supply lead and of a lead for connecting to the central processing unit.

13. A device according to claim 1, wherein the forces comprise shear forces and traction forces.

14. A device according to claim 3, wherein the protective sheet is made from stainless steel.

15. A device according to claim 2, wherein the protective sheet is made from a metallic material.

16. A device according to claim 2, wherein the protective sheet is made from a carbon fiber-based composite material or an aromatic polyamide fiber-based composite material.

17. A device according to claim 2, wherein the protective sheet is prestressed to values greater than 0 N and less than or equal to 500 N.

18. A device according to claim 2, wherein the protective sheet is prestressed by being wound at both ends around respective rollers, at least one of the rollers being a tensioning roller.

19. A device according to claim 1, wherein the sensor has a resolution less than or equal to 1 mm².
